(19) United States
(12) Patent Application Publication
(10) Pub. No.: US 2003/0218689 A1
(43) Pub. Date: Nov. 27, 2003

(54) Camera with LED lighting source for illuminating a scene to be photographed

(76) Inventors: Gerald Angeli, N. Miami Beach, FL (US); Erwin Scholz, Miramar, FL (US); Joseph Tang, Miramar, FL (US)

Correspondence Address: Kerry Sisselman, Concord Camera Corp., Suite 650N, 4000 Hollywood Blvd., Hollywood, FL, 33021, US

(21) Appl. No.: 10/372,632

(22) Filed: Feb. 21, 2003

Related U.S. Application Data
(63) Continuation-in-part of application No. 10/081,143, filed on Feb. 22, 2002.

(51) Int. Cl. H04N 5/222

(52) U.S. Cl. 348/370

(57) ABSTRACT

An external lighting source for a camera is provided. A visible spectrum light emitting diode or diodes is/are used instead of the conventional gas tube flash mechanism of a camera to bathe a scene in bright visible light. A reflector directs the light from the LED(s) outward from the camera to illuminate a scene in a fairly uniform manner during the image capture period.

### PRIORITY

The present application is a continuation-in-part application of co-pending U.S. patent application Ser. No. 10/081,143 filed on Feb. 22, 2002.

### FIELD OF THE INVENTION

The present invention relates to the field of cameras, and more particularly, to a camera flash device wherein the external lighting source comes from light emitting diodes.

### BACKGROUND OF THE INVENTION

Cameras including infrared emitting diodes are known. U.S. Pat. No. 4,866,285 to Simms discloses an infrared flash unit for use with a camera employing infrared film. The '285 patent describes a flash unit having a front panel with an array of eight individual reflectors, each containing an infrared emitting diode. U.S. Pat. No. 6,275,256 to Olczak, et al., discloses a digital camera illuminator including a body of transparent material defining a cone shaped cavity with an opening at the apex of the cone for a taking lens of the camera and an opening at the base of the cone for locating an object to be photographed with the digital camera. A plurality of infrared emitting diodes are uniformly distributed throughout the body of transparent material.

Additionally, it is known to use laser generators and/or laser diodes to project a visible frame profile to assist in framing a photograph. U.S. Pat. No. 5,589,905 to McIntyre discloses a camera including a visible light framing emitter that produces a scanned visible beam of light which outlines a portion of the ambient scene to be recorded and appears, for example, as a readily visible red rectangular frame on the scene. The framing aid emitter is deactivated when the image capture mechanism of the camera is active. U.S. Pat. No. 6,178,297 to Ting discloses a camera with laser view framing function. When a switch key is pressed, the laser generator is actuated to emit a laser beam, which passes through the frame profile hole of the shade to form a profile light frame framing an area of which a user is taking a picture. Both cameras disclosed in the '297 and '905 patents include separate flash components in addition to the laser generator/laser diode profile generators.

What is needed is a camera including an LED light source that bathes a scene to be photographed with visible light.

This and other objects and advantages of the present invention will become more readily apparent in the description that follows.

### SUMMARY OF THE INVENTION

What is provided is a lighting source for a camera that is particularly useful under low ambient lighting conditions at close range. A visible spectrum light emitting diode, such as a white LED, is provided in a camera, instead of the conventional gas tube flash mechanism. A reflector housed in the front of the camera directs the light from the LED toward the scene to be captured in order to bathe the scene in bright visible light during image capture. A simple circuit for operating the LED is provided. As such, no complicated flashboards containing expensive capacitors are required.

These and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

The foregoing summary, as well as the following detailed description of the preferred embodiments, is better understood when read in conjunction with the appended drawings. For the purpose of illustrating the invention, there is shown in the drawings an exemplary embodiment that is presently preferred, it being understood, however, that the invention is not limited to the specific methods and instrumentality's disclosed. In the drawings:

FIG. 1 is a front perspective view of a camera including the LED lighting source of one embodiment of the present invention.

FIG. 2 is a simplified front plan view of an internal portion of a camera including an LED lighting source in accordance with one embodiment of the present invention.

FIG. 3 is a front perspective view of a camera including an LED lighting source in accordance with another embodiment of the present invention.

FIG. 4 is a front perspective cutaway view of a camera including an LED lighting source in accordance with the embodiment of FIG. 3.

FIG. 5 is a front perspective cutaway view of a camera including an LED lighting source in accordance with another embodiment of the present invention.

FIG. 6 is a front perspective view of a camera in accordance with another embodiment of the present invention.

FIG. 7 is a front perspective view of a camera in accordance with another embodiment of the present invention.

FIG. 8 is a circuit diagram of one embodiment of the present invention.

### DETAILED DESCRIPTION OF THE PREFERRED EMBODIMENTS

Before explaining the disclosed embodiment of the present invention in detail, it is to be understood that the invention is not limited in its application to the details of the particular arrangement shown since the invention is capable of other embodiments. Also, the terminology used herein is for the purpose of description and not of limitation.

A camera is provided including as its external communication source a visible spectrum light emitting diode (LED) to fairly uniformly bathe a scene to be photographed in direct visible light from the LED. The LED of the present invention is provided instead of a camera's conventional gas tube flash having a charged capacitor trigger circuit.

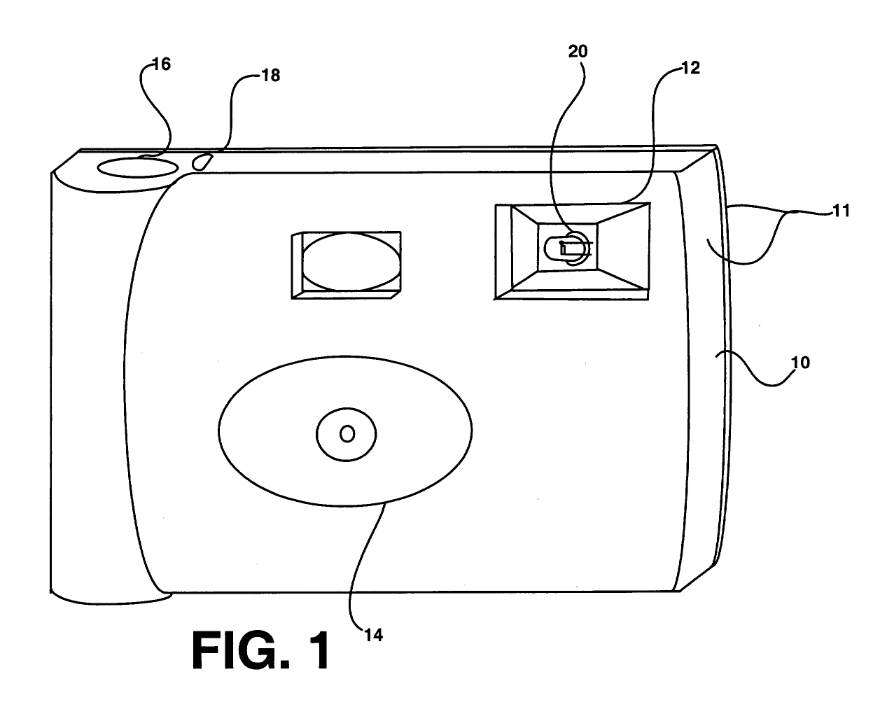

Referring now to FIG. 1, there is shown a camera 10 in accordance with one embodiment of the present invention. The camera 10 includes an outer housing 11. Additionally, a focusing reflector 12, a taking lens 14, the trigger button 16 and an exposure indicator 18 for indicating the pictures remaining in the unexposed film roll are included in camera 10. A bright visible light emitting diode (LED) 20 is placed in the focusing reflector 12, preferably in the center. In the present embodiments, a white visible light emitting diode is most preferred. White LEDs emit bright white light in the visible spectrum when powered and have been found to last about 100,000 hours of continuous use. A white LED acts as a very bright point source for illumination, making the present invention particularly well suited for taking pictures at close range.

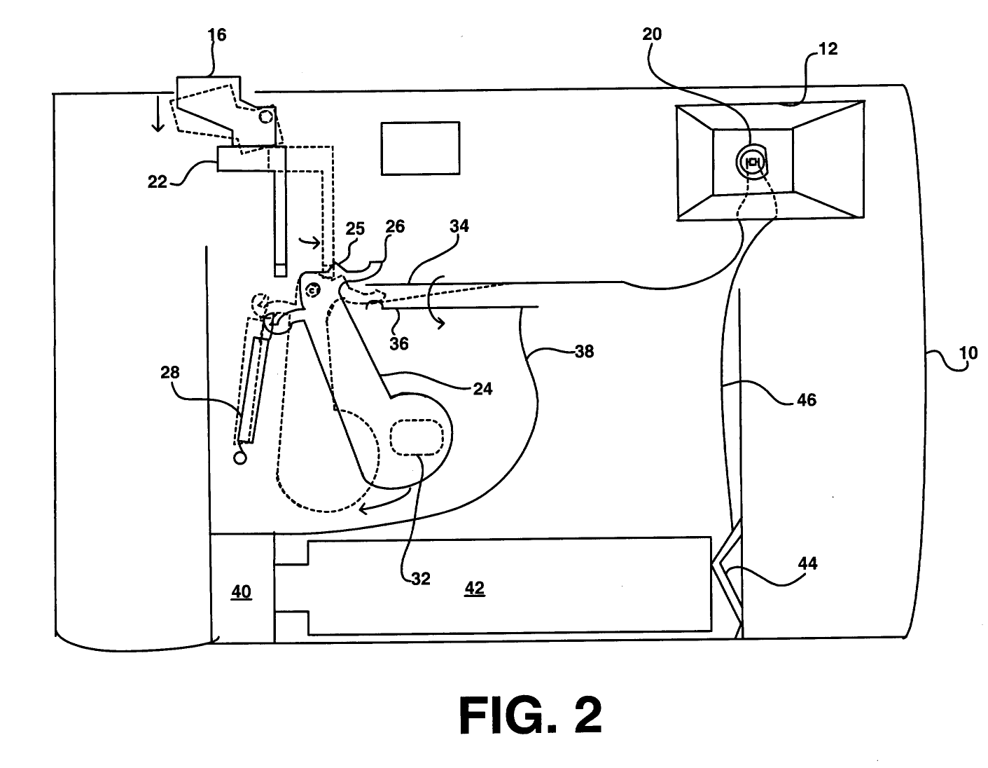

Referring now to FIG. 2, there is shown a simplified view of the front inside portion of the camera 10 made in accordance with one embodiment of the present invention. In the present embodiment, the operation of the white LED 10 is activated for the duration of the shutter operation.

More specifically, advancing the film using a winding wheel (not shown) cocks a striker 22 (shown in the cocked position in solid). When cocked, the striker 22 is spring loaded by a torsion spring (not shown). Taking a picture by pressing the shutter trigger 16 moves the striker 22, causing the torsion spring to drive the striker 22 across a spur 25 on the shutter blade 24. The striker 22 remains on the other side of the spur 25 until the striker 22 is again cocked by winding the film. When passing over the spur 25, the striker 22 causes the shutter blade 24 to swing, exposing the shutter aperture 32 for an instant (1/30^{th} of a second to 1/60^{th} of a second) to expose the film.

Additionally, striking the spur 25 rotates the shutter blade 24 (as shown in shadow) on the pivot pin 25 and extends the coil spring 28. As soon as the striker 22 passes over the spur 25, the coil spring 28 returns to its rest position, pivoting the shutter blade 24 back over the exposure aperture 32.

The shutter blade 24 additionally includes a switch arm 26. As the striker 22 passes over the spur 25, pivoting the shutter blade 24, the switch arm 26 biases a spring contact 34 against the spring contact 36, closing the circuit. The spring contacts 34, 36 remain closed while the exposure aperture 24 is exposed. Note that changing the length of the spring contact 34 and/or the angle of the arm 26 can adjust the length of time the spring contacts 34, 36 are closed.

Additionally, the camera 10 includes electrodes 40 and 44 in contact with the anode and cathode of a battery 42, respectively. A white LED has a voltage drop of 3.6 volts. As such, the battery 42 should be chosen so as to adequately power the LED. Additionally, a current limiting resistor may optionally be added to the circuit.

The anode electrode 40 is connected to the spring contact 36 by a wire 38. The spring contact 34 is connected to the positive terminal of the LED 20 by a wire 35. Similarly, the cathode electrode 44 is connected to the negative terminal of the LED 20, by the wire 46. When the two spring contacts are closed, the battery 42 lights the LED 20 during the image capture period.

In operation, illumination of the LED is timed with the movement of the shutter blade 24, through the current specific design of the shutter blade 24 and arm 26. When the shutter blade 24 swings open, the arm 26 closes the contacts 34, 36 bathing the scene in bright white visible light from the LED 20. As the shutter blade 24 returns to cover the exposure aperture 32, the arm 26 lifts from the spring contact 34, permitting the spring contact to return to its rest position and, thus, turning off the LED 20.

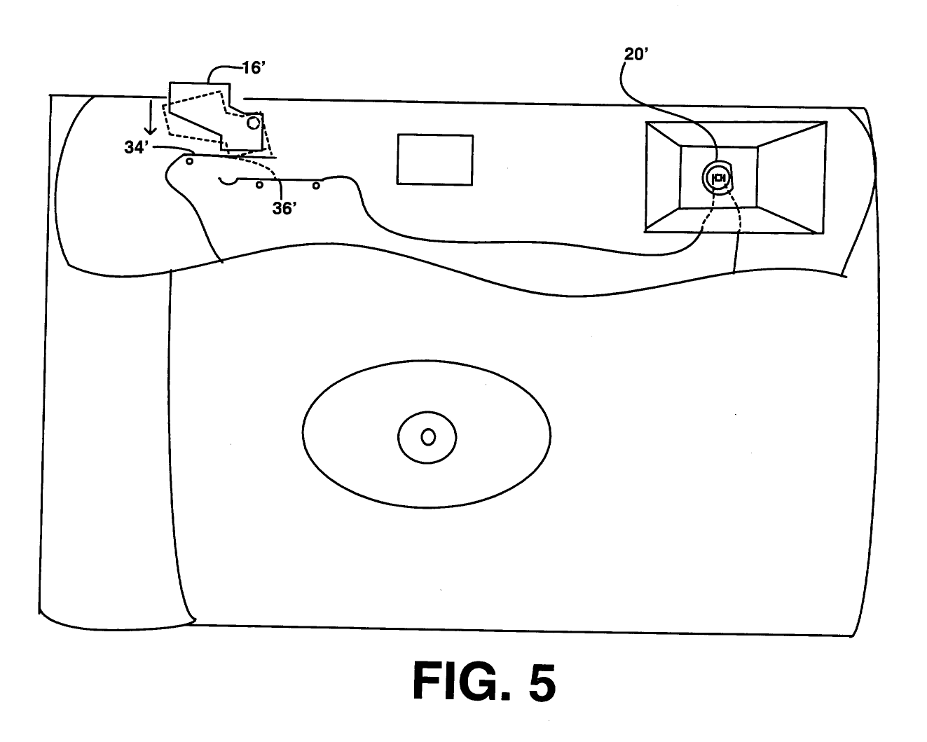

Note that this is not meant to be limiting, other means may be used to close the spring contacts 34, 36. For example, referring now to FIG. 5, there is shown another embodiment of the present invention wherein the spring contacts 34′, 36′ are located proximal to the trigger 16′, such that depression of the trigger directly closes the spring contacts 34′, 36′, lighting the LED 20′. As can be seen, the LED of the present embodiment will remain lit so long as the trigger 16′ is pressed. This differs from the previous embodiment wherein depression of the trigger 16 indirectly actuates the LED by setting the striker in motion, and wherein the pivoting of the shutter blade 24 controls the length of time the LED is lit. Alternatively, the circuit of FIG. 5 may include additional elements not shown, such as a one-shot multivibrator or a microprocessor, interposed between the trigger and the flash such that actuation of the trigger results in a momentary flash of the LED 20′ timed to coincide with the capture of a scene.

Additionally, the present invention is equally applicable for use in digital cameras. For example, a digital camera may be provided that activates one or more LEDs upon actuation of the photo trigger button. For example, the embodiment shown in connection with FIG. 5 is especially useful in connection with a digital camera, which may not have a physical/mechanical shutter. Rather the camera of FIG. 5 may include an image processor and an image sensor, which are used to capture a scene when the trigger button 16′ is actuated. Other embodiments described herein would additionally be useful for both digital and film based cameras.

As can be seen, other methods of closing the circuit to actuate the LED flash 20′ of FIG. 5 may be employed. For example, instead of using spring contacts 34′ and 36′, the LED actuation switch may comprise metallic traces on a printed circuit board (PCB) located beneath the trigger button, such that depression of the trigger button will bridge the traces of the PCB switch and initiate activation of the LED flash 20′. Other switch methods may be used to actuate the LED flash, such as a Hall magnetic switch or other known forms of PCB switch.

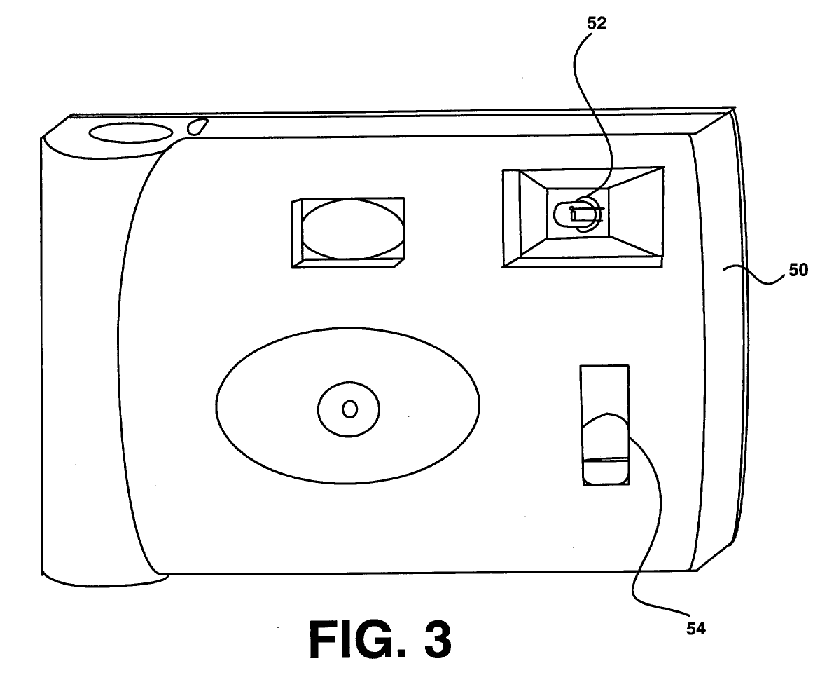

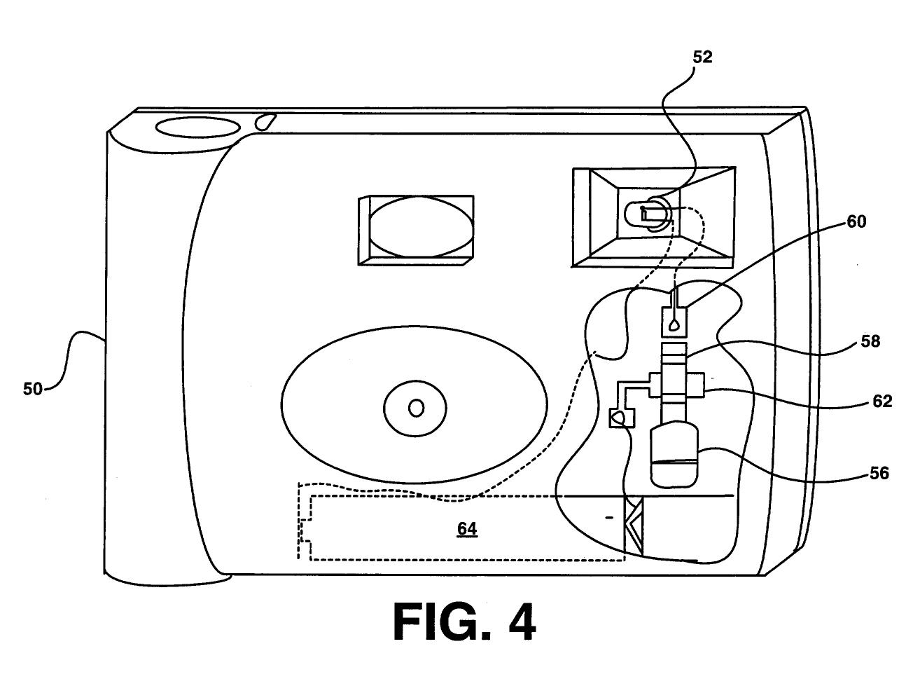

Referring now to FIGS. 3 and 4 there is shown another embodiment of a camera 50 made in accordance with the present invention. The camera 50 includes a light focusing reflector 52 having LED 52 centered therein. In the present embodiment, rather than synchronizing the flash with the opening of the exposure aperture, a switch 54 is provided to turn on the LED 52. In the present preferred embodiment, the external switch plate 56 is attached to a sliding metal contact 58. The anode of the battery 64 is connected to the positive terminal of the LED 52. The cathode of the battery 64 is connected to the negative terminal of the LED 52 via the contact pads 60 and 62, and the sliding metal contact 58, when the switch 54 is closed. Note that, again a battery 64 must be chosen sufficient to power the LED.

In operation, the user slides the external switch plate 56 from a first open position to a second closed position. This slides the sliding metal contact 58 into position to conduct across the gap between the switch electrode pads 60 and 62 and completes the circuit, turning on the LED 52. After the picture(s) has/have been taken, the user may slide the external switch plate 56 back to the first position, breaking the connection between the electrodes 60, 62 and turning off the LED 52. Optionally, additional circuitry may be provided to strobe the LED 52 while the switch 54 and LED 52 are on.

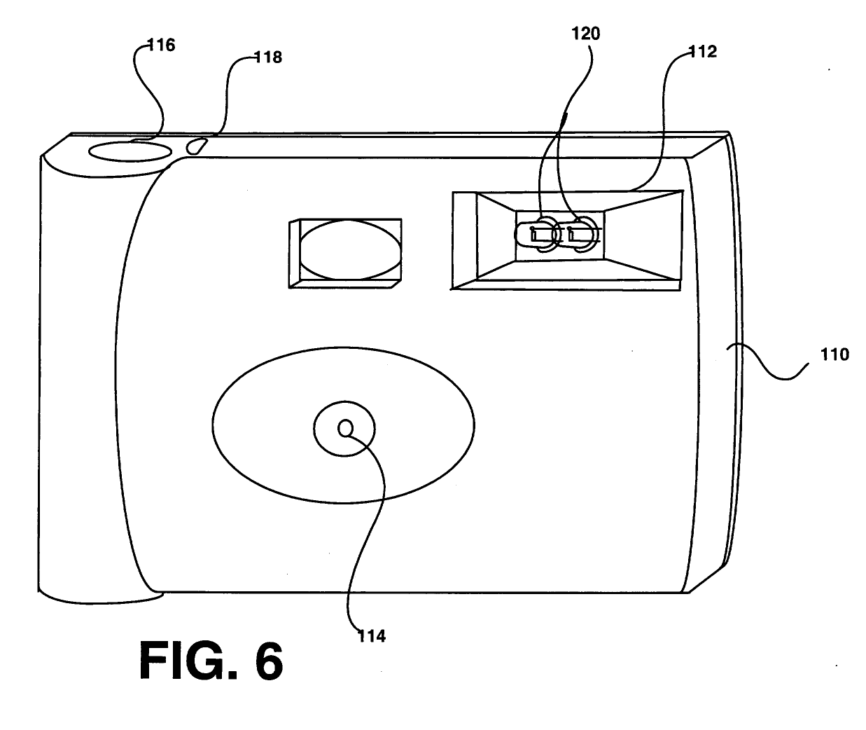

Referring now to FIG. 6, there is shown another embodiment of the present invention using a plurality of LEDs 120 provided in series. The operation of the LED lighting source of the embodiment of FIG. 6 may be similar to those explained in connection with the embodiments of FIGS. 1-5. However, a battery or multiple batteries that can accommodate a plurality of 3.6 volt drops must be provided. Additionally, although two LEDs are shown in the preferred embodiment of FIG. 6, more LEDs may be provided, if desired.

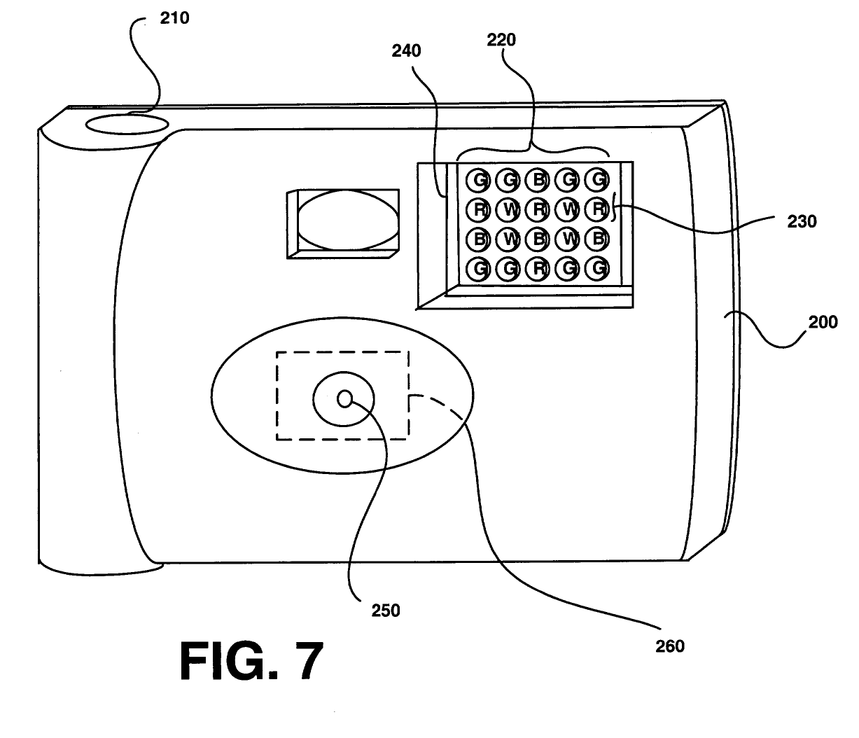

In addition to the embodiment shown in FIG. 6, the digital or film based camera using an LED flash in accordance with the present invention may employ a plurality of visible light LEDs that are not, necessarily, chosen to be white LEDs. For example, referring now to FIG. 7, there is shown a one particular embodiment of a camera 200 utilizing an array 220 of red, green and blue LEDs, in addition to white LEDs, wherein red LEDs are represented by “R”, white LEDs by “W”, green LEDs by “G” and blue LEDs by “B”. In one particular embodiment, the LEDs are mounted in front of a reflector 230 to direct the light outward from the camera 200. Two examples of reflectors that may be used with the present particular embodiment are made by EDMUND OPTICS, part numbers 54-083 and 54-084. Additionally, in one particular embodiment the light from the LEDs may be diffused using a diffusion lens. Two such diffusion lenses are the sandblasted diffusion lenses made by EDMUND OPTICS, part numbers 43-724, 43-725.

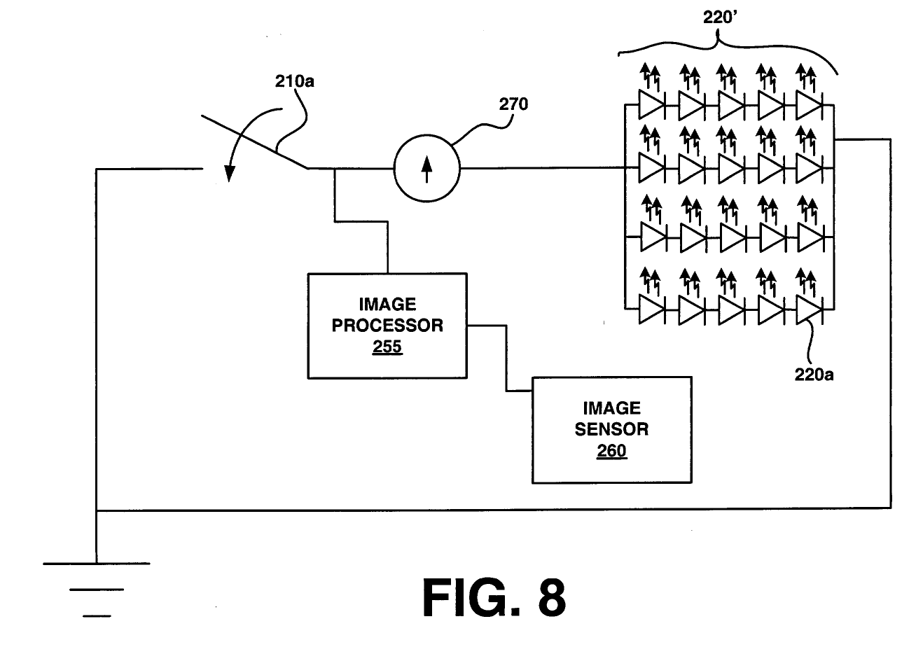

In such a camera 200, the LED array 220 is triggered by actuation of the photo trigger button 210. The actuation of the trigger button 210 is additionally used to capture a scene through the taking lens 250 either by triggering a mechanical shutter to temporarily expose a shutter aperture or by informing an image processor (255 of FIG. 8) to obtain, process and store the image of the scene currently on the image sensor, 260 of FIG. 7, in the case of digital cameras.

The colors red, green and blue have been chosen in the present particular example because they combine optically to form white light. As such, in a colored LED array, such as LED array 220, more green than red or blue LEDs are used in accordance with the typical formulation for obtaining white light from these primary colors. In the present embodiment, the ratio of green:red:blue is approximately 2:1:1. In the present embodiment, the white LEDs are added to increase the intensity of the light projected from the LED array 220. If the red, green and blue LEDs were of an intensity to, by themselves, sufficiently illuminate a scene, the white LEDs could be omitted.

Other combinations of visible light LEDs can be provided to obtain a suitable result. For example, the array of TABLES 1 or 2 could be used in place of the LED color array 220:

TABLE 1

| | | | | |
|---|---|---|---|---|
| G | B | G | B | G |
| R | W | W | W | R |
| R | W | W | W | R |
| G | B | G | B | G |

TABLE 2

| | | | | |
|---|---|---|---|---|
| G | B | G | B | G |
| R | W | B | W | R |
| G | W | G | W | G |
| R | G | B | G | R |

wherein red LEDs are represented by “R”, white LEDs by “W”, green LEDs by “G” and blue LEDs by “B”.

However, other arrangements of the visible light LEDs may be used. For example, visible light colored LED arrays may be made using more LEDs or fewer LEDs than illustrated in the present embodiments. Additionally, as described above in connection with FIG. 6, an LED array can be formed using all white LEDs, or all colored LEDs, or as shown in connection with FIG. 7, a mixture of colored and white visible LEDs. Additionally, non-rectangularly configured arrays of LEDs may be used.

A voltage boosting circuit may be included in the camera to provide a higher voltage, but constant current, to the LED flash mechanisms described in connection with FIGS. 1-7. In this way the camera and flash may still be run using more traditional batteries, such as a 1.5 V AA battery, or a 3 V CR123 battery.

Referring now to FIG. 8, in an LED array 220′ of the type shown in FIG. 7, Tables 1 and 2, the LEDs may be connected such that the LEDs 220a in each row are in series with each other, and each row is connected in parallel with the other rows. It can also be seen that there are other ways to electrically connect the LEDs 220a into the circuit. It can additionally be seen that the LEDs 220a in the LED array 220′ may be all white LEDs 220a or all colored LEDs 220a, or a mixture of white LEDs 220a and colored LEDs 220a.

If desired, actuation of the camera trigger button can close a switch 210a that will initiate a pulse of high current from a current source 270 to the LEDs 220a to flare the LEDs 220a for a short period of time with the capture of the image (either with the opening of the shutter in a mechanical shutter system or while electronically recording the scene on the image sensor 260 in a digital camera system, as shown). Alternatively, the image processor 255 may be activated by the closing of switch 220a and the image processor may control the lighting of the LEDs 220a through a separate line (not shown) so as to coordinate the lighting of the LEDs with the capture of a scene.

In one particular embodiment, actuation of the trigger button provides a 100 mA pulse of current to the LED(s), causing it/them to flash very brightly for an instant. If an array of LEDs is used, the current source may be arranged to provide 100 mA of current per row of the array. In another embodiment, actuation of the trigger button also triggers the LED(s) for a predetermined duration, during which the current is spiked for a short portion of the total LED illumination period to cause the LED(s) to flare brighter in that short portion.

The use of LED(s) as a flash mechanism instead of more traditional gas bulb/charging capacitor flash mechanisms has a number of advantages. First, an LED flash mechanism draws less current than the charging capacitor of more traditional flash system. Further, the LED flash mechanisms described herein can be used to repetitively illuminate a scene for multiple shots taken during a short period of time, whereas the more traditional system must wait for the capacitor to recharge between shots.

While the invention has been described with reference to a preferred embodiment, it will be understood by those skilled in the art that various changes may be made and equivalents may be substituted for elements thereof without departing from the scope of the invention. For example, although the foregoing has been illustrated using traditional dual lead LEDs, other forms of LEDs (i. e., surface mount, solid state) can be used in connection with the present invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A camera comprising:
an outer housing;
a visible light LED, visible through said outer housing;
a camera lens through which a scene may be captured;
a mechanism to capture a scene through said lens;
a trigger, at least a portion of which extends through said outer housing, wherein actuation of said trigger activates said mechanism to capture the scene and additionally initiates the lighting of said visible light LED to illuminate the scene to be captured.

2. The camera of claim 1, wherein said visible light LED is a white LED.

3. The camera of claim 2, wherein said mechanism includes a mechanical shutter blade.

4. The camera of claim 3, wherein the camera additionally includes an exposure aperture disposed behind said shutter, and wherein actuation of said trigger causes said mechanism to open said shutter to expose said exposure aperture, said trigger additionally initiating the lighting of said visible light LED while said shutter is open.

5. The camera of claim 4, wherein the camera includes at least a second visible light LED, the lighting of which is additionally initiated by actuation of said trigger.

6. The camera of claim 2, wherein said mechanism includes an image sensor.

7. The camera of claim 2, additionally including a second visible light LED, the lighting of which is additionally initiated by actuation of said trigger.

8. The camera of claim 7, wherein said second visible light LED is a white LED.

9. The camera of claim 7, wherein said second visible light LED is a colored LED.

10. The camera of claim 9, wherein said second visible light LED is one of a red LED, a green LED and a blue LED.

11. The camera of claim 10, wherein said mechanism includes an image sensor.

12. The camera of claim 1, wherein said visible light LED is a colored LED.

13. The camera of claim 12, further including a plurality of LEDs, wherein said plurality of LEDs is chosen from the group including red LEDs, green LEDs and blue LEDs.

14. The camera of claim 13, wherein there are aproximately twice as many green LEDs as blue LEDs or red LEDs.

15. The camera of claim 14, wherein said plurality of LEDs additionally includes at least one white LED.

16. A camera comprising:
an outer housing;
a visible light LED outwardly disposed from said outer housing;
a camera lens through which a scene may be captured;
a mechanism to capture a scene through said lens;
a trigger, at least a portion of which extends through said outer housing, wherein actuation of said trigger activates said mechanism to capture the scene; and
a switch separate from said trigger, said switch mounted through said outer housing, wherein actuation of said switch initiates the lighting of said visible light LED to illuminate the scene to be captured while said switch is closed.

17. The camera of claim 16, further including a plurality of visible light LEDs connected in series with said visible light LED.

18. A camera comprising:
an outer housing;
an array of visible light LEDs, visible through said outer housing, wherein said array includes a plurality of rows of visible light LEDs, each row of said plurality of rows including a plurality of serially connected LEDs, said plurality of rows being connected in parallel;
a camera lens through which a scene may be captured;
a mechanism to capture a scene through said lens;
a trigger, at least a portion of which extends through said outer housing, wherein actuation of said trigger activates said mechanism to capture the scene and additionally initiates the lighting of said array of visible light LEDs to illuminate the scene to be captured.

19. The camera of claim 18, wherein said array of visible light LEDs comprises white LEDs

20. The camera of claim 18, wherein said array of visible light LEDs comprises colored LEDs

21. The camera of claim 20, wherein said colored LEDs include red LEDs, green LEDs and blue LEDs.

22. The camera of claim 21, wherein there are approximately two green LEDs for every one blue LED and one red LED.

23. The camera of claim 20, further including at least one white LED.

24. The camera of claim 20, wherein said mechanism includes an image sensor.

25. The camera of claim 20, wherein said array includes four rows of LEDs including five LEDs per row.

26. The camera of claim 25, wherein the current across each row of LEDs is about 100 mA.

27. The camera of claim 18, further including a reflector seated within said outer housing to reflect the light from said LED array forward.

28. The camera of claim 27, further including a diffusion lens in front of said LED array to diffuse the light from said LED array.
